(19) United States
(12) Patent Application Publication
(10) Pub. No.: US 2021/0178828 A1
(43) Pub. Date: Jun. 17, 2021

(54) Tire Having a Tread Combining Inclined Sipes with a Specific Material

(71) Applicant: COMPAGNIE GENERALE DES ETABLISSEMENTS MICHELIN, Clermont-Ferrand (FR)

(72) Inventors: Tony ZIVKOVIC, Clermont-Ferrand Cedex 9 (FR); Perrine VALLAT, Clermont-Ferrand Cedex 9 (FR)

(21) Appl. No.: 16/761,797

(22) PCT Filed: Nov. 7, 2018
(86) PCT No.: PCT/FR2018/052757

§ 371 Date: May 5, 2020

(30) Foreign Application Priority Data
Nov. 7, 2017 (FR) 1760438

(51) Int. Cl. B60C 11/03; B60C 11/12

(52) U.S. Cl. CPC B60C 11/0323; B60C 2011/0025; B60C 11/124; B60C 11/1281

(57) ABSTRACT

Heavy-duty vehicle tire, with tread (1) of thickness E of wearable material and surface (10) for contact with a roadway, tread (1) having a raised element (41, 42) with of sipes (5) circumferentially distributed and inclined. Tread (10) material is an elastomer based on natural rubber or synthetic polyisoprene with a majority of cis-1,4 linkages and on a reinforcing filler predominantly of silica, with a content expressed in phr (parts by weight per hundred parts of elastomers) of greater than 40 and a filler content in phr of greater than 50, and having: a tan(δ)max/(G*25%) ratio at most of 0.065, in which tan(δ) is the measurement, at 60° C., of the loss factor of the tread material, and G*25% is the complex dynamic shear modulus, expressed in MPa, and a deformation at break under tensile testing at least equal to 530%, at a temperature of 60° C.

### FIELD OF THE INVENTION

The present invention relates to treads for tires intended to be fitted to transport vehicles and, more particularly, to heavy-duty vehicles liable to make long journeys at sustained speed.

### PRIOR ART

As is known, a tire for a heavy-duty vehicle comprises a tread intended to come into contact with a roadway during running, this tread being extended by sidewalls, the latter ending in beads intended to collaborate with a mounting rim.

This tire comprises a carcass reinforcement made up of a plurality of reinforcers extending from one bead of the tire to the other, this carcass reinforcement being itself surmounted by a crown reinforcement extending in the circumferential direction to make a complete circuit of the tire.

The crown reinforcement is also surmounted on its radially exterior surface with a tread produced with at least one rubber compound of which the radially outermost part forms a tread surface, this tread surface being intended to come into contact with the roadway when the said tire is running.

In order to obtain satisfactory grip performance when running on a roadway that may be covered with water, particularly in rainy weather, this tread is provided on its tread surface with a tread pattern design made up of grooves of suitable orientation. For example, in the case of a tire intended to be fitted to the steered front axle of a heavy-duty vehicle, this tread pattern is usually made up of a plurality of grooves of circumferential overall orientation. These circumferential grooves delimit a plurality of circumferential ribs, each one of these ribs having a contact face radially on the outside, and lateral walls that may or may not be perpendicular to the contact face of the rib. The intersection of each lateral wall of a rib with the contact face generates an edge corner of material. When the tread of a tire is provided with both transverse and circumferential grooves, these grooves delimit blocks which each have a contact face forming part of the tread surface.

Furthermore, it is known practice to form, in the ribs or the blocks, sipes having suitable widths such that, as they enter the contact patch in contact with the roadway, the opposing walls that delimit these sipes can close up and come at least partially into contact with one another. The benefit of the presence of these sipes is firstly that they form new edge corners of material on the contact face of the ribs and of the blocks, these edge corners serving to cut through a film of water present on the roadway in rainy weather with the objective of ensuring contact between the tread and the said roadway. Furthermore, these same sipes constitute a volume for storing water when they enter the contact patch, this volume adding to the volume of the grooves.

### Definitions

An equatorial mid-plane is a plane perpendicular to the axis of rotation and passing through the points of the tire that are radially furthest from the said axis.

In the present document, a radial direction means a direction which is perpendicular to the axis of rotation of the tire (this direction corresponds to the direction of the thickness of the tread).

A transverse or axial direction means a direction parallel to the axis of rotation of the tire.

A circumferential direction means a direction tangential to any circle centred on the axis of rotation. This direction is perpendicular both to the axial direction and to a radial direction.

The total thickness of a tread is measured, on the equatorial plane of the tire provided with this tread, between the tread surface and the radially outermost part of the crown reinforcement when new.

A tread has a maximum thickness of material that can be worn away during running, this maximum thickness of wearable material being less than the total thickness of the tread.

The usual running conditions of the tire or use conditions are those which are defined notably by the E.T.R.T.O. standard for running in Europe; these use conditions specify the reference inflation pressure corresponding to the load-bearing capacity of the tire as indicated by its load index and its speed rating. These conditions of use can also be referred to as “nominal conditions” or “working conditions”.

A cut generically denotes either a groove or a sipe and corresponds to the space delimited by walls of material that face one another and are at a non-zero distance (referred to as the “width of the cut”) from one another. It is precisely this distance that distinguishes a sipe from a groove; in the case of a sipe, this distance is appropriate for allowing the opposing walls that delimit the said sipe to come into at least partial contact at least when they enter the contact patch in contact with the roadway. In the case of a groove, the walls of this groove cannot come into contact with one another under the usual running conditions as defined for example by the E.T.R.T.O.

In the prior art, it is also known practice to provide the ribs or the blocks with a plurality of sipes making an angle other than 90 degrees with respect to the tread surface, it being possible for this angle either to be constant or variable through the thickness of the tread.

For example, document EP 810104 A1 shows a tread comprising a plurality of sipes of which the mean angle of inclination in the vicinity of the contact face changes progressively with the wearing of the tread.

Another example is described in document EP1264713 B1; in that document, there is proposed a tread pattern for tires intended to be fitted to the front axle of heavy-duty vehicles, having at least one rib by virtue of which it is possible to reduce uneven wear while at the same time having a low overall mean wear rate, the improvement to these performance aspects giving the tire a better life-to-wear property.

What is meant here by uneven wear is wear that is localized, namely wear which develops on specific regions of the tread surface of the tread rather than evenly across the entirety of this tread surface.

That document EP1264713-B1 describes a tread for a tire intended to be fitted to the front axle of a heavy-duty vehicle, this tire having a preferred direction of running and comprising a radial carcass reinforcement surmounted by a crown reinforcement, this tread comprising grooves of circumferential overall orientation of depth H delimiting ribs, each rib of width B having a contact face intended to be in contact with the roadway and two lateral faces that intersect the contact face to form two edge corners, at least one of the ribs being equipped near to each of its edge corners with a plurality of sipes of transverse overall orientation opening onto the contact face and having a width of less than 1.5 mm and a depth at least equal to 40% of the depth H of the grooves, these sipes, which are substantially mutually parallel, having within the thickness of the tread a non-zero mean inclination A with respect to the direction perpendicular to the tread surface of the tread when new so that the resultant force exerted during running in the zone of contact with the roadway by the said roadway on the tread tends to straighten the sipes towards a mean inclination that is zero with respect to this perpendicular, this tread being such that, viewed in a plane of section perpendicular to the axis of rotation of the tire, each sipe of the one same rib has, with respect to a perpendicular to the contact face of the said rib at the point of intersection of the said sipe with the said face, an inclination that is variable through the thickness of the tread, each sipe being inclined with respect to the said perpendicular, at its point of intersection with the tread surface when new, by an angle B1, the angle B1 being greater than the angle A, and by an angle B2 at the point of the sipe that is furthest towards the inside of the tread, the angle B2 being smaller than the angle A, the point of the said sipe furthest towards the inside in the tread being situated, with respect to the said perpendicular, in such a way as to be forward of the point of the sipe that is situated on the contact face of the rib.

Viewed in section, a point of a sipe that is situated on the inside of a circumferential rib is said to be forward of the point of the sipe with the contact face of the rib when new when a radial plane (plane containing the axis of rotation of the tire) passing through the point of the sipe on the contact face when new has to be rotated in the recommended direction of rotation corresponding to the preferred direction of running of the tire, in order to bring it onto the point of the sipe on the inside of the tread.

Viewed in section, the mean overall inclination of a sipe is given by the angle made with the radial direction by the direction of a straight-line segment connecting the point of the sipe on the contact face of the rib and the innermost point of the sipe considered in the same plane of section perpendicular to the axis of rotation.

Aside from the absence of uneven tire wear on heavy-duty vehicles, it is essential to develop tires that have the lowest possible rolling resistances so as to reduce the fuel consumption of the vehicles as they run.

In order to achieve a reduction in the fuel consumption, it is known practice to work on the materials of the tire and more particularly on the materials of which the tread is made in an attempt to define materials that have hysteresis properties that limit as far as possible the energy losses that result from the deformations of the tire with each revolution of the wheel.

One object of the invention is to form a new tire for a heavy-duty vehicle, this tire having improved performance in terms of rolling resistance and also exhibiting good performance in terms of uneven wear.

What is meant here by performance in terms of rolling resistance is the amount of energy dissipated by the tire during running, this amount of energy being connected with the cycles of deformation experienced by the tire and its components. This dissipated energy is connected with the hysteresis properties of the rubber materials used in the manufacture of the tire.

### BRIEF DESCRIPTION OF THE INVENTION

The objective that the applicant company has set itself is that of creating a tire for a heavy-duty vehicle that has both low rolling resistance and good performance in terms of uneven wear, while at the same time exhibiting a large number of edge corners generated by the presence of a plurality of sipes.

To this end, there is proposed a tire for a heavy-duty vehicle, this tire comprising a tread having a thickness E of wearable material and a tread surface intended to come into contact with a roadway.

Formed in this tread are:
at least one raised element (rib, block), this raised element having a contact face forming part of the tread surface of the tread, lateral faces intersecting the contact face along edge corners, each raised element having a height at least equal to the thickness of wearable material,
in which this at least one raised element is provided with a plurality of sipes distributed in the circumferential direction, these sipes being inclined, namely making an angle other than zero degrees with a radial plane perpendicular to the contact face of the raised element, these inclined sipes extending through the thickness of the tread and intersecting the contact face of the raised element to form edge corners, these inclined sipes having suitable widths such that they close up at least partially when they enter the contact patch in contact with the roadway.

This tire is characterized in that the material of the tread that is intended to be in contact when new with roadway is an elastomer compound based on natural rubber or synthetic polyisoprene with a majority of cis-1,4 linkages and optionally on at least one other diene elastomer, the natural rubber or the synthetic polyisoprene in case of a blend being present in a majority amount relative to the amount of the other diene elastomer(s) used and on a reinforcing filler consisting predominantly of silica, with a content expressed in phr (parts by weight per hundred parts of elastomers) of greater than 40 and an overall filler content expressed in phr of greater than 50,

this material further having the following physical properties:

a tan(δ)max/(G*25%) ratio at most equal to 0.065, in which tan(δ)max is the measurement, at 60° C., of the loss factor of the material of which the tread is made, and G*25% is the complex dynamic shear modulus, expressed in MPa, of this material as obtained according to the recommendations of standard ASTM D 5292-96.
a deformation at break under tensile testing that is at least equal to 530%, this value being obtained at a temperature of 60° C. according to the recommendations of French standard NF T 46-002.

An inclined sipe has a width that is small and suitable for it to close up when the walls delimiting it move closer together and come at least partially in contact with one another when they enter the contact patch in contact with the roadway.

The mean plot of a sipe on the contact face of the rib corresponds to a straight-line segment passing equidistantly from the opposing edge corners formed by the intersection of the sipe with the contact face.

As a preference, the tread according to the invention is devoid of any non-inclined sipe, namely of any sipe that makes a zero angle with a radial plane (plane containing the axis of rotation perpendicular to the tread surface and intersecting the mean plot of the sipe).

As a preference, the strain at break under tensile testing is at least equal to 570%.

Dynamic Properties of the Materials of which the Tread is Made

The dynamic properties and in particular tan(δ)max, representative of the hysteresis, are measured on a viscosity analyser (Metravib VA4000) according to standard ASTM D 5992-96. The response of a sample of the vulcanized composition (cylindrical test specimens 2 mm thick and 78 mm² in cross section taken from the tire), subjected to a simple alternating sinusoidal shear stress, at a frequency of 10 Hz, at a temperature of 60° C. is recorded. A strain amplitude sweep is carried out from 0.1% to 100% peak-peak (outward cycle) and then from 100% to 0.1% peak-peak (return cycle). The results exploited are the complex dynamic shear modulus (G*) and the loss factor tan(δ). For the outward cycle, the maximum value of tan(δ) observed, denoted tan(δ)max; and also the modulus G* at 25% strain, denoted G*25%, are indicated.

Tensile Tests

The value of deformation at break under elongation is determined on a tensile measurement. The tensile tests make it possible to determine the stress/strain curves and the properties at break. These tests are carried out in accordance with French standard NF T 46-002 of September 1988. The tensile measurements are carried out at 60° C. and under standard hygrometry conditions (50±10% relative humidity). The strains at break are expressed as percentages.

Each inclined sipe has a mean inclination equal to the angle made, with respect to a radial plane containing the axis of rotation of the tire passing through the mean plot of the sipe on the tread surface when new, by a straight line passing through the plot of the sipe on the tread surface when new and through the points of the sipe furthest towards the inside of the tread.

Advantageously, the maximum value of tan (δ), denoted tan(δ)max and measured at 60° C. for the material which, when new, forms the external layer of the tread, is less than or equal to 0.10.

Advantageously, the complex dynamic shear modulus G*25% of the material which, when new, forms the external part of the tread, measured at 25% and 60° C. on the outbound cycle, is greater than or equal to 2.

As a preference, the material of which the outermost layer of the tread when new is made is an elastomer compound based on natural rubber or synthetic polyisoprene with a majority of cis-1,4 linkages and optionally on at least one other diene elastomer, the natural rubber or the synthetic polyisoprene in case of a blend being present in a majority amount relative to the amount of the other diene elastomer(s) used and on a reinforcing filler consisting predominantly of a specific silica, with a content expressed in phr (parts by weight per hundred parts of elastomers) of greater than 40 and an overall filler content expressed in phr of greater than 50, which has the following characteristics:

(a) a BET specific surface area of between 200 and 240 and preferably between 210 and 230 m2/g;
(b) a CTAB specific surface area of between 180 and 220 and preferably between 190 and 210 m2/g;
(c) an average particle size (by mass), denoted dw, of from 45 to 75 nm.

Description of the Methods for Characterizing the Silica:

The BET specific surface area (“surface area per unit mass”) is determined by gas adsorption using the Brunauer-Emmett-Teller method described in “The Journal of the American Chemical Society”, vol. 60, page 309, February 1938, more specifically according to French standard NF ISO 9277 of December 1996 [multipoint (5 point) volumetric method—gas: nitrogen—degassing: 1 hour at 160° C.—relative pressure p/po range: 0.05 to 0.17].

The CTAB specific surface area is the external surface area determined according to French standard NF T 45-007 of November 1987 (method B).

The average particle size (by mass), denoted dw, is measured in a conventional manner after dispersion, by ultrasonic deagglomeration, of the filler to be analysed in water.

The measurement is carried out using an X-ray detection centrifugal sedimentometer of XDC (X-ray Disc Centrifuge) type, sold by Brookhaven Instruments, according to the following procedure.

A suspension of 3.2 g of silica sample to be analysed in 40 ml of water is produced by the action over 8 minutes, at 60% power (60% of the maximum position of the “output control”), of a 1500 W ultrasonic probe (¾ inch Vibracell sonicator sold by Bioblock); after sonification, 15 ml of the suspension is introduced into the rotating disc; after sedimentation for 120 minutes, the distribution by mass of the particle sizes is calculated by the XDC sedimentometer software. The geometric mean, by mass, of the particle sizes (“geometric mean (Xg)” according to the name of the software), denoted dw, is calculated by the software from the following equation:

$$log {d}_{w} = \frac{{\sum }_{i = 1}^{n} {m}_{i} log {d}_{i}}{{\sum }_{i = 1}^{n} {m}_{i}}$$

with mi being the mass of all objects in the diameter di class.

The L/IF parameter characterizing the pore size distribution width is determined by mercury porosimetry. The measurement is carried out using the PASCAL 140 and PASCAL 440 porosimeters sold by ThermoFinnigan, operating as follows: an amount of sample of between 50 and 500 mg (in the present case 140 mg) is introduced into a measurement cell. This measurement cell is installed in the measurement station of the PASCAL 140 device. The sample is then degassed under vacuum for the time necessary to reach a pressure of 0.01 kPa (typically of the order of 10 minutes). The measurement cell is then filled with mercury. The first part (pressures of less than 400 kPa) of the mercury intrusion curve Vp=f(P), where Vp is the mercury intrusion volume and P is the applied pressure, is determined on the PASCAL 140 porosimeter. The measurement cell is then installed in the measurement station of the PASCAL 440 porosimeter, the second part of the mercury intrusion curve Vp=f(P) (pressures between 100 kPa and 400 MPa) being determined on the PASCAL 440 porosimeter. The porosimeters are used in “PASCAL” mode, so as to continuously adjust the rate of intrusion of the mercury as a function of the variations in the intrusion volume. The rate parameter in “PASCAL” mode is set to 5. The pore radii Rp are calculated from the pressure values P using the Washburn equation, recalled below, assuming that the pores are cylindrical, choosing a contact angle θ equal to 140° and a surface tension γ equal to 480 dynes/cm.

$$Washburn equation \text{:} {R}_{p} = \frac{- 2 γ cos θ}{P}$$

The pore volumes Vp are relative to the mass of silica introduced and are expressed in cm3/g. The signal Vp=f(Rp) is smoothed by combining a logarithmic filter (“smooth dumping factor” filter parameter F=0.96) and a moving-average filter (“number of points to average” filter parameter f=20). The pore size distribution is obtained by calculating the derivative dVp/dRp of the smoothed intrusion curve.

By definition, the fineness index IF is the value of pore radius (expressed in angstroms) corresponding to the maximum of the pore size distribution dVp/dRp. The width at half maximum of the pore size distribution dVp/dRp is denoted by L. The pore size distribution width of the sample is then characterized using the L/IF parameter.

The number of silanols per nm² is determined by grafting methanol onto the surface of the silica. Firstly, an amount of approximately 1 g of crude silica is suspended in 10 ml of methanol in a 110 ml autoclave (Top Industrie, Ref: 09990009).

A magnetic bar is introduced and the reactor, hermetically sealed and thermally insulated, is heated to 200° C. (40 bar) on a magnetic hot plate stirrer for 4 hours. The autoclave is then cooled in a cold water bath. The grafted silica is recovered by decantation and the residual methanol is evaporated off under a stream of nitrogen. Finally, the grafted silica is dried at 130° C. under vacuum for 12 hours. The carbon content is determined by elemental analysis (NCS 2500 analyser from CE Instruments) on the crude silica and on the grafted silica. This carbon assay on the grafted silica must be performed within 3 days of the end of drying. This is because atmospheric moisture or heat could bring about hydrolysis of the methanol grafting. The number of silanols per nm2 is calculated using the following formula:

$${N}_{SiOH \text{/} {nm}^{2}} = \frac{( {\%}_{{C}_{g}} \times {\%}_{{C}_{b}} ) \times 6.023 \times {10}^{23}}{{S}_{spe} \times {10}^{18} \times 12 \times 100}$$

NsioH/nm2: number of silanols per nm2 (SiOH/nm2)

% cg: weight percentage of carbon present on the grafted silica

% cb: weight percentage of carbon present on the crude silica 3

Sspe: BET specific surface area of the silica (m2/g).

Advantageously, the specific silica also has at least one of the following characteristics, preferably two and more preferably still, all three:
a particle size distribution such that dw≥(16 500/CTAB)−30,
a porosity that satisfies the criterion L/IF>−0.0025 CTAB+0.85,
a content of silanols per unit area, denoted NSiOH/nm2, such that NSiOH/nm2<−0.027 CTAB+10.5.

Advantageously, the sum of the sulfur content and accelerator content is greater than or equal to 2.5 parts by weight per 100 parts by weight of elastomer (phr).

Advantageously, the sulfur content, expressed in phr, is greater than or equal to 1.4.

As a preference, the angle of inclination of the inclined sipes with respect to a radial plane is at least equal to 5 degrees and at most equal to 20 degrees and more preferably still, at least equal to 8 degrees and at most equal to 20 degrees.

Advantageously, the angle of the sipes varies from the tread surface progressing towards the inside of the tread. As a preference, the angle is comprised between 5 and 20 degrees at the tread surface and then decreases in the direction towards the inside of the tread.

As a preference, the inclined sipes have widths at most equal to 2 mm, and more preferably still, comprised between 0.6 mm and 1.2 mm (end-points included) in order to promote an effect of mechanical coupling through contact between the opposing walls that delimit each sipe when it enters the contact patch in contact with the roadway.

As a preference, each inclined sipe has a depth which is at least equal to 40% of the wearable thickness of tread. The material intended to be in contact with the roadway when new and having the properties listed in the main claim, extends over a height at least equal to the depth of the deepest inclined sipes.

According to one advantageous variant of the invention, the tread comprises at least two layers of materials that are superposed in the radial direction, the material of the layer which when new is radially outermost having the following physical properties:
a tan(δ)max/(G*25%) ratio at most equal to 0.065, G*25% being expressed in MPa,
a strain at break at least equal to 530% and more preferably still, at least equal to 570%,

and, radially on the inside of this external layer, an internal layer formed from a material chosen to be a weak dissipator and to have the following physical properties:
a tan(δ)max/(G*25%) ratio of less than 0.085, G*25% being expressed in MPa,
a tan(δ)max value of less than 0.09.

In the event that there are in the tread at least two layers of materials superposed in the radial direction, the inclined sipes extend in the outermost layer and at most into 10% of the thickness of the innermost layer. As a preference, the inclined sipes are not present in the innermost internal layer which is not per se necessarily intended to come into contact with the roadway after the tread has become worn.

Advantageously, the thickness of the innermost internal layer of the tread is comprised between 10% and 40% of the total thickness of the tread.

Advantageously, each inclined sipe is provided with a widening at its end furthest towards the inside of the tread so as to reduce stress concentrations in the bottom of the sipe.

Advantageously, the inclined sipes in the thickness of the tread may also have plots on the tread surface when new which are inclined at a mean angle other than zero with respect to the axis of rotation of the tire. The latter inclination is given by the angle between a straight-line segment plotted between the ends of the sipe on the tread surface and the axis of rotation.

According to one advantageous variant of the invention, at least certain raised elements form ribs, the latter being provided with short inclined sipes that open only onto a lateral wall of these ribs so as to limit the onset of rail wear on the edge corners of these ribs.

According to another variant of the invention, the tread may comprise a plurality of blocks distributed in at least one circumferential row, the blocks being separated from one another by grooves, these grooves being inclined in the same way as the inclined sipes with which these blocks are provided.

According to one advantageous variant of the invention, the inclined sipes open only onto a lateral wall of a raised element.

Of course, each inclined sipe may further comprise means for ensuring mechanical blocking of the opposing walls of material that delimit this sipe. Such means may consist in the presence of a geometry that zigzags in some direction or another, or in the presence of roughnesses on the walls.

Further features and advantages of the invention will become apparent from the following description provided with reference to the appended drawings which show, by way of non-limiting examples, embodiments of the subject matter of the invention.

### BRIEF DESCRIPTION OF THE FIGURES

FIG. 1 depicts a partial view of the tread surface of a tread according to one variant of the invention;

FIG. 2 depicts a view in transverse section of the crown part of the tire on a plane of section the plot of which is indicated by II-II in FIG. 1;

FIG. 3 shows a view in cross section of the tread shown in FIG. 1 on a plane of section the plot of which is indicated by

### DESCRIPTION OF THE FIGURES

In order to make the figures easier to understand, identical reference signs have been used to describe variants of the invention where these reference signs refer to elements of the same kind, whether structurally or functionally.

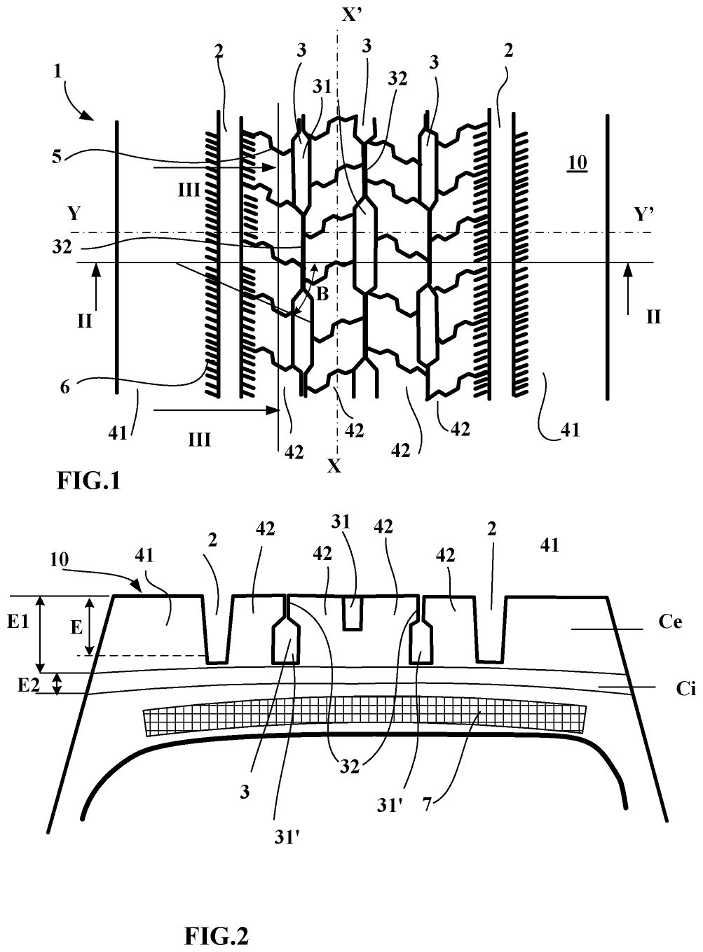

FIG. 1 depicts part of the tread surface 10 of a tread 1 of a heavy-duty tire (315/70R22.5), the said tread surface being intended to come into contact with a roadway when the tire is running.

In this variant of tire according to the invention, it may be seen that this tire, intended to be fitted to the steered axle of a heavy-duty vehicle, comprises a tread 1 which when new has two main grooves 2 of circumferential orientation (indicated by the direction XX′ in FIG. 1), these main grooves 2 being entirely open onto the tread surface 10 when new. These main grooves 2 have a depth when new which is slightly greater than the thickness E of tread material to be worn away, so as to ensure a lasting performance, notably in rainy weather (in this instance, the thickness E is equal to 10.5 mm). The thickness E of wearable material is determined as being the thickness beyond which the tread has to be renewed by re-capping or the tire has to be changed, the remaining depth of the grooves and voids having reached a pre-set limit value.

The circumferential main grooves 2 have a maximum depth equal to 12 mm.

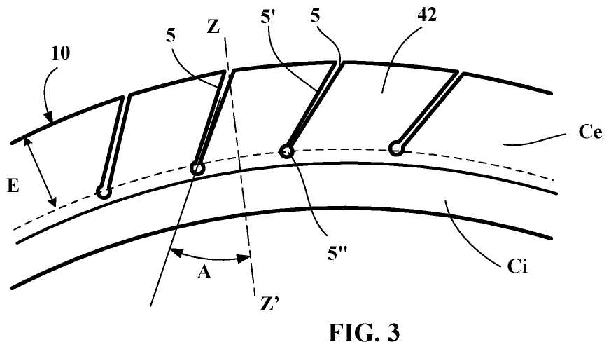

Furthermore, the tread 1 comprises three wavy grooves 3 oriented mainly in the circumferential direction. These wavy grooves 3 are formed of a plurality of parts 31 opening onto the tread surface of the tread when new, these open parts being extended into the tread by hidden parts 31′ (visible in FIG. 2) hidden inside the thickness of the tread.

The grooves together delimit two edge ribs 41 axially on the outside of the tread and, between these edge ribs 41, four intermediate ribs 42.

FIGS. 2 and 3 show partial sections through the tire of which part of the tread surface is shown in FIG. 1. Visible in these FIGS. 2 and 3 are the layers that make up the tread: an external layer Ce, positioned radially on the outside and intended to come into contact with the roadway when new, this external layer Ce surmounting an internal layer Ci which in theory is not intended to come into contact with the roadway as long as the user does not exceed the predefined wear limit.

FIG. 2 shows a transverse section through the crown part of the tire shown in FIG. 1, this transverse section being taken in a plane containing the axis of rotation (parallel to the direction YY′) and of which the plot in FIG. 1 is indicated by II-II.

This sectional view shows the superposition of an external layer Ce and of an internal layer Ci of the tread 1. The external layer Ce has a thickness E1 equal to 12 mm, and the internal layer Ci has a thickness E2 equal to 3 mm. The thickness E of wearable material in this instance is equal to 10.5 mm.

The circumferential main grooves 2 and the circumferentially oriented wavy grooves 3 are formed in the external layer Ce by moulding, these grooves delimiting edge ribs 41 and intermediate ribs 42. In the case of the wavy grooves 3 it is possible to distinguish groove parts 31 that are open onto the tread surface 10 when new and groove parts 31′ that are hidden beneath the tread surface 10 when new. Sipes 32′ extend the groove parts 31 that are open onto the tread surface 10 down to a depth equal to the depth of the circumferential main grooves 2. The hidden groove parts 31′ are extended towards the tread surface 10 when new by sipes 32 that make the tire easier to mould and to demould. The hidden groove parts 31′ extend in the thickness of the tread down to a depth equal to that of the circumferential main grooves 2.

This same FIG. 2 schematically shows the crown reinforcement 7 of the tire radially beneath the tread 1.

FIG. 3 shows a partial cross section of an intermediate rib 42, this section being taken on a plane perpendicular to the axis of rotation and the plot of which is indicated by III-III in FIG. 1.

This intermediate rib 42 is provided with a plurality of inclined sipes 5 opening onto the two lateral faces of the intermediate rib 42 and having, on the tread surface 10, as is visible in FIG. 1, a zigzag plot. Furthermore, each of these sipes is inclined, in the plane of FIG. 1, at a constant mean angle B to the axial direction indicated by the direction YY′ in FIG. 1, this mean angle B in this instance being equal to 25 degrees. This mean angle B is obtained as the angle made by the segment connecting the start and end of the plot of a sipe on the tread surface with respect to the axis of rotation indicated by the direction YY′. In the example described, only the sign of this mean angle B changes from one rib to another.

All of the sipes 5 have a mean width equal to 0.8 mm allowing the walls delimiting them to come into even partial contact.

These sipes 5 are also, and as can be seen in FIG. 3, inclined in the thickness of the tread at a constant angle A with respect to a radial plane passing through the mean plot of the sipe on the tread surface when new. By definition, a radial plane is a plane which contains the axis of rotation. In FIG. 3, the plot of a radial plane passing through the sipe at the tread surface is represented by the direction ZZ′. The angle of inclination in the depth of the tread is 15 degrees here. The magnitude of this angle A is the same for all the inclined sipes formed on the four intermediate ribs and is constant through the depth of the tread.

The inclined sipes 5 comprise a rectilinear part 5′, ending in an enlargement 5″ of maximum width equal to 2 mm. These inclined sipes 5 extend as far as a depth equal to 11 mm, which is less than the thickness of the external layer Ce but greater than the thickness of wearable material E in this instance so as to maintain the presence of these sipes throughout the service life of the tire.

In FIG. 1 it may be seen that the ribs 41, 42 flanking the circumferential main grooves 2 are also provided with a plurality of short sipes 6 opening only onto these main grooves 2. These short sipes 6 contribute as is known to improving the wearing performance of the tire. These short sipes 6 are both inclined with respect to the axis of rotation (direction YY′) and inclined in the thickness of the tread with respect to the radial direction (ZZ′) in the same way as the inclined sipes 5 formed on the intermediate ribs and described hereinabove. It must be understood here that the short sipes 6 are oriented in the same way as the inclined sipes 5 but not necessarily with the same magnitude of angle.

Combined with this tread pattern design, several tread materials were tested and compared. A reference material, denoted T in the table below, and a specific material, denoted M are used as the material for the external layer Ce of the tread.

The compositions and properties of these materials T and M are listed in the table below (the values of the constituents are expressed in phr, which is, by weight, parts per hundred rubber):

| Component | Material | Material |
|---|---|---|
| (phr) | T | M |
| NR | 100 | 80 |
| BR | | |
| SBR Tg-48° C. | | 20 |
| Black N234 | 42 | 3 |
| Silica 165G | 10 | |
| Sil P200 | | 50 |
| Antioxidant | 2.5 | 2.5 |
| (6PPD) | | |
| Stearic acid | 2 | 2.5 |
| Zinc oxide | 3 | 1 |
| Silane, liquid | 0.5 | 6.25 |
| Sulfur | 1 | 1.5 |
| Accelerator CBS | 1.7 | 1.8 |
| Accelerator | | |
| TBBS | | |
| Coaccelerator | | 0.62 |
| DPG | | |
| CBS + S | 2.7 | 3.3 |

Properties

| | | |
|---|---|---|
| G* (25% outward) | 1.7 | 2.3 |
| MPa | | |
| tan(δ)ₘₐₓ | 0.15 | 0.10 |
| tan(δ)ₘₐₓ / G*25% | 0.088 | 0.043 |
| strain at break | 572 | 570 |
| under tensile load | | |
| (%) | | |

In the above table:
tan(δ)ₘₐₓ is the measurement at 60° C. of the loss factor of the material of which the tread is made, and G*25% is the measurement of the complex dynamic shear modulus of this material as obtained in accordance with the recommendations of standard ASTM D 5292-96;
the strain at break under tensile load is obtained at a temperature of 60° C. in accordance with the recommendations of French standard NF T 46-002.

The silica used for the material M has the characteristics reproduced in the table below:

| | Silica Zeosil Premium |
|---|---|
| Filler | 200 |
| BET surface area (m²/g) | 220 |
| CTAB surface area (m²/g) | 200 |
| d_{w} (nm) | 62 |
| L/IF | 0.62 |
| N_{SiOH/nm}_{²} | 3.90 |

The material constituting the internal layer Ci placed radially beneath the external layer Ce of the tread is a customary heavy-duty tire tread material and has the following physical properties:
a tan(δ)max/(G*25%) ratio equal to 0.075, in which tan(δ)max is the measurement, at 60° C., of the loss factor of the material of which the tread is made, and G*25% is the complex dynamic shear modulus, expressed in MPa, of this material as obtained according to the recommendations of standard ASTM D 5292-96;
a tan(δ)max value equal to 0.085.

In the table below, the performance obtained with the reference material T used in the tread, this tread being provided with non-inclined sipes, is compared with the test material M used in the tread, this tread being provided or not provided with inclined sipes as described above.

A value of greater than 100 indicates an improvement expressed as a percentage.

| Tire performance | Material T | Material M | Material M |
|---|---|---|---|
| | Non-inclined | Non-inclined | Inclined sipes |
| | sipes | sipes | |
| Rolling resistance | 100 | 108 | 108 |
| (base 100) | | | |
| Uneven wear (base | 100 | 95 | 100 |
| 100) | | | |

Non-inclined sipes means sipes oriented perpendicular to the tread surface.

It is found that only the combination of a material M and inclined sipes leads both to an improvement in the rolling resistance and to maintained performance in terms of uneven wear by comparison with the reference tire using the reference material and non-inclined sipes.

The invention also relates to a tire provided with a tread as claimed and even more particularly to a tire intended to be fitted to the steering axle of a heavy-duty vehicle. In such a case, the tire is provided with a tread which is itself provided with a tread pattern formed of a plurality of circumferential ribs delimiting circumferential grooves.

Of course, the invention is not limited to the example described and various modifications can be made thereto without departing from the scope as defined by the claims.

1. A tire for a heavy duty vehicle, comprising a tread having a thickness E of wearable material and a tread surface intended to come into contact with a roadway, this tread having at least one raised element, this raised element having a contact face forming part of the tread surface, lateral faces intersecting the contact face along edge corners, each raised element having a height at least equal to the thickness of wearable material, this at least one raised element being provided with a plurality of sipes distributed in the circumferential direction, these sipes being inclined, namely making an angle other than zero degrees with a radial plane perpendicular to the contact face of the raised element, these inclined sipes extending through the thickness of the tread and intersecting the contact face of the raised element to form edge corners, these inclined sipes having suitable widths such that they close up at least partially when they enter the contact patch in contact with the roadway, wherein the material of the tread that is intended to be in contact when new with a roadway is an elastomer compound based on natural rubber or synthetic polyisoprene with a majority of cis-1,4 linkages and optionally on at least one other diene elastomer, the natural rubber or the synthetic polyisoprene in case of a blend being present in a majority amount relative to the amount of the other diene elastomer(s) used and on a reinforcing filler consisting predominantly of silica, with a content expressed in phr (parts by weight per hundred parts of elastomers) of greater than 40 and an overall filler content expressed in phr of greater than 50, this material further having the following physical properties:
a tan(δ)max/(G*25%) ratio is at most equal to 0.065, in which tan(δ)max is the measurement, at 60° C., of the loss factor of the material of which the tread is made, and G*25% is the complex dynamic shear modulus, expressed in MPa, of this material as obtained according to the recommendations of standard ASTM D 5292-96, and
a deformation at break under tensile testing that is at least equal to 530%, this value being obtained at a temperature of 60° C. according to the recommendations of French standard NF T 46-002.

2. The tire according to claim 1, wherein the deformation at break under tensile testing of the material which when new forms the radially external part (Ce) of the tread is at least equal to 570%.

3. The tire according to claim 1, wherein the maximum value of tan(δ), denoted tan(δ)max and measured at 60° C. for the material which, when new, forms the external part of the tread, is less than or equal to 0.10.

4. The tire according to claim 1, wherein the complex dynamic shear modulus G*25% of the material which, when new, forms the external part of the tread, measured at 25% and 60° C. on the outbound cycle, is greater than or equal to 2 MPa.

5. The tire according to claim 1, wherein the material of which the outermost layer (Ce) of the tread when new is made is an elastomer compound based on natural rubber or synthetic polyisoprene with a majority of cis-1,4 linkages and optionally on at least one other diene elastomer, the natural rubber or the synthetic polyisoprene in case of a blend being present in a majority amount relative to the amount of the other diene elastomer(s) used and on a reinforcing filler consisting predominantly of a specific silica, with a content expressed in phr (parts by weight per hundred parts of elastomers) of greater than 40 and an overall filler content expressed in phr of greater than 50, which has the following characteristics:
(a) a BET specific surface area of between 200 and 240 and preferably between 210 and 230 m2/g;
(b) a CTAB specific surface area of between 180 and 220 and preferably between 190 and 210 m2/g;
(c) an average particle size (by mass), denoted dw, of from 45 to 75 nm.

6. The tire according to claim 1, wherein the specific silica also has at least one of the following characteristics:
a particle size distribution such that dw≥(16 500/CTAB)−30,
a porosity that satisfies the criterion L/IF>−0.0025 CTAB+0.85,
a content of silanols per unit area, denoted NSiOH/nm2, such that NSiOH/nm2<−0.027 CTAB+10.5.

7. The tire according to claim 1, wherein the sum of the sulfur content and accelerator content of the material which when new forms the external part of the tread is greater than or equal to 2.5 parts by weight per 100 parts by weight of elastomer (phr).

8. The tire according to claim 1, wherein the sulfur content, expressed in phr, is greater than or equal to 1.4.

9. The tire according to claim 1, wherein the angle (A) of inclination of the inclined sipes with respect to a radial plane is at least equal to 5 degrees and at most equal to 20 degrees.

10. The tire according to claim 1, wherein the angle (A) of the sipes varies from the tread surface progressing towards the inside of the tread.

11. The tire according to claim 1, wherein the inclined sipes have widths at most equal to 2 mm.

12. The tire according to claim 1, wherein the inclined sipes have a depth which is at least equal to 40% of the wearable thickness of the tread.

13. The tire according to claim 1, wherein the tread comprises at least two layers of materials that are superposed in the radial direction, the material of the layer which when new is radially outermost having the following physical properties:
a tan(δ)max/(G*25%) ratio at most equal to 0.065,
a strain at break at least equal to 550%, and
the material that completes the tread radially on the inside being chosen to be a weak dissipater and such that it has the following physical properties:
a tan(δ)max/(G*25%) ratio of less than 0.085,
a tan(δ)max value of less than 0.09.

14. The tire according to claim 13, wherein the thickness of the innermost internal layer of the tread is comprised between 10% and 40% of the total thickness of the tread.

15. The tire according to claim 1, wherein the inclined sipes have widths at most equal to 2 mm.

16. The tire according to claim 1, wherein the tire is intended to equip a steering axle of a heavy-duty vehicle.
